(19) United States
(12) Patent Application Publication
(10) Pub. No.: US 2003/0065537 A1
(43) Pub. Date: Apr. 3, 2003

(54) System and method for displaying drug information

(75) Inventor: Robert F. Evans, Mobile, AL (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: DocuSys, Inc., Mobile, AL

(21) Appl. No.: 10/233,646

(22) Filed: Sep. 3, 2002

Related U.S. Application Data
(60) Provisional application No. 60/316,568, filed on Aug. 31, 2001.

(51) Int. Cl. G06F 17/60; G09G 5/00

(52) U.S. Cl. 705/2; 345/810

(57) ABSTRACT

A drug administration data management and display system includes a storage device for storing drug data including a database of drugs by drug classification and/or color designators. A pharmacy workstation is provided for entering drug data for storage by the storage device. An anesthesia workstation is provided for accessing the drug data in the storage device in response to a drug monitoring system for displaying on a display an icon identifying the drug being administered, the icon including one or more of syringe graphics, drug graphics, drug name, drug concentration, drug administration amount and/or coded background color. The drug monitoring system provides for drug identification and monitoring of drug administration in real time.

### CROSS REFERENCE TO RELATED APPLICATIONS

The present application claims the benefit of provisional application No. 60/316,568, filed Aug. 31, 2001, which is incorporated herein by reference.

### BACKGROUND OF THE INVENTION

The present invention relates in general to drug delivery systems, and more particularly, to a system and method for use during drug delivery to a patient which improves the quality of the information transmitted to the physician or other health care professional.

Manual dispensing of drugs from pharmacy to anesthesia is a common practice in hospitals and other surgical facilities. Anesthesia providing departments generally fill syringes with drugs, administer the drugs directly to the patient and document afterwards using handwritten entries. Human imperfection makes drug diversion, medication errors, errors of admission, medication contamination and inadvertent needle sticks a constant companion to drug administration. Additionally, the process is exacerbated by emergency situations and production pressures which demand hurried setup and administration of drugs, with concurrently less time to pay attention to timely and accurate record keeping.

A study conducted in Australia noted that administering the wrong drug in the practice of clinical anesthesia was quite common, occasionally having serious effects on the patient. Strategies suggested to address the wrong drug problem included education of staff about the nature of the problem and the mechanisms involved; color coding of labels for selected drug classes for both supply containers, such as ampoules, vials and syringes; the use of standardized drug storage, layout and selection protocols; having a drawing up and labeling convention; and the use of checking protocols. See Alan F. Merry, Craig S. Webster and Daniel J. Mathew, Anesth Analg, A New, Safety-Oriented, Integrated Drug Administration and Automated Anesthesia Record System, Vol. 93, pp. 385-90, 2001; PCT WO 99/11306, Mar. 11, 1999; and M. Currie, P. Mackay, C. Morgan, W. B. Runcimans, W. J. Russell, A. Sellen, R. K. Webb, and J. A. Williamson, The “Wrong Drug” Problem in Anaesthesia: An Analysis of 2000 Incident Reports, Anaesth Intens Care, Vol. 21, pp. 596-601, 1993.

One solution to these problems is disclosed in Walker, et al., U.S. Pat. No. 5,651,775 assigned to the same assignee of the present application, the subject matter of which is incorporated herein by reference. Walker, et al. discloses a drug delivery and administration monitoring system whereby drugs are identified, safely delivered to a patient, monitored in real time during delivery and crucial events are recorded during delivery to provide on-line information and details for an audit trail. The basic components of the drug delivery and monitoring system include a scanning module, a syringe label cradle, a cassette tray and a drug injection port. The syringe label cradle is designed as a holder and positioner for a drug containing syringe. The syringe label cradle is constructed in a plurality of sizes to accommodate varying sizes of syringes to provide a constant needle height of the combined unit independent of the syringe volume, i.e., syringe barrel diameter. The syringe is positioned within the cradle and preferably securely affixed thereto by a self adhesive, preprinted label. The label provides drug identification indicia and drug preparation information which can be in the form of human and/or machine readable indicia. The information on the label is automatically read into the system from the label using, for example, a scanning module.

A plurality of syringe label cradle units, i.e., combination syringe label cradle and syringe, are placed within a cassette tray for transport and storage prior to, during and after use. Generally, the cassette tray is organized to hold the syringe label cradles and drug loaded syringe in a logically progressive array. In use, the syringe label cradle is aligned with the injection port which is most commonly connected to a patient-connected needleless IV injection set. The scanning module incorporates bar code or other digital indicia scanners to read the labels affixed to the syringe label cradle. Information contained on the label is in the nature of a code identifying, for example, the drug contained in an associated syringe, size of the syringe, syringe type, preparer of the drug and any expiration date associated with the drug. The scanning module also is used to monitor the syringe plunger movement as the drug is administered, thus acquiring drug administration dynamics in real-time, i.e., determining delivery rate and volume of administered drugs.

There is however the desirability for further improvements in systems and methods for displaying drug information which is usable by the health care professional for reducing human errors while administering drugs to patients.

### SUMMARY OF THE INVENTION

Computerized records in medicine are becoming more prevalent and the design and arrangement of display systems which include a display monitor such as a CRT or LCD display can affect usability and effectiveness. The more information feedbacked to the user the better probability of reducing human errors while administering drugs to patients. In accordance with one aspect of the present invention, the display system provides a visual image of a familiar representation of the delivery device, e.g., a syringe. The delivery device's position on the display monitor is preferably made to correspond with the location where the drug information is going to be or is recorded. As such, the user's attention is drawn to this documentation event and certain visual signals such as color may be incorporated thereby reducing the likelihood of drug delivery errors.

During most surgical and other intensive procedures, a great many data items may be collected. This clinical information can be organized into records or displays which reflect patient care events, procedures or other therapies. If the presentation of this information is confusing or distracting, the usefulness of the information is reduced and may disorient the practitioner. Knowing where to examine the display record for these data items is made faster and more direct by helping the practitioner to visualize where certain specific pieces of information are being and are to be recorded. When a clinician's attention is directed to relevant information, other signals such as color may be utilized to give additional feedback to the clinician. If a clinician accidentally picks up the wrong syringe, the characteristics of the display can help to signal the clinician to this error and reduce the chance of inadvertent medication mistakes.

In accordance with one embodiment of the present invention there is described a drug administration data management and display system including a display, a storage device for storing drug data including a database of drugs by drug classification and/or color designators, a pharmacy workstation for entering drug data for uploading to the storage device, a drug monitoring system for drug identification and monitoring of drug administration in real time, and an anesthesia workstation for accessing the drug data in the storage device in response to the drug monitoring system for displaying on the display an icon identifying the drug being administered, the icon including one or more of syringe graphics, drug graphics, drug name, drug concentration, drug administration amount and coded background color.

In accordance with one embodiment of the present invention there is described a drug administration display system including a display, and a computer programmed to display an icon on the display identifying a drug to be administered to a patient, the icon including one or more of syringe graphics, drug graphics, drug name, drug concentration, drug administration amount and coded background color.

In accordance with one embodiment of the present invention there is described a method of recording drug administration to a patient in real time, the method includes providing a display for indicating the amount of a drug being administered to a patient in real time, displaying an icon identifying the drug being administered on the display proximate to the location displaying the amount of the drug being administered, determining the amount of the drug being administered in real time, and displaying on the display at the location the amount of the drug administered in real time, wherein the icon including one or more of syringe graphics, drug graphics, drug name, drug concentration, drug administration amount and coded background color.

In accordance with one embodiment of the present invention there is described a method of identifying a drug to be administered to a patient including indicating on a display an icon identifying a drug to be administered to a patient, the icon including one or more of syringe graphics, drug graphics, drug name, drug concentration, drug administration amount and coded background color.

In accordance with one embodiment of the present invention there is described a drug administration display system comprising a display, a storage device for storing drug data, a first station for entering drug data for storage by the storage device, a drug monitoring system for monitoring drug administration, and a workstation for accessing the drug data in the storage device in response to the drug monitoring system for displaying on the display an icon including indicia identifying the drug being administered.

In accordance with one embodiment of the present invention there is described a drug display system comprising a display, and a computer programmed to display an icon on the display including indicia identifying a drug to be administered to a patient.

In accordance with one embodiment of the present invention there is described a method for identifying a drug for administration to a patient, the method comprising displaying on a display an icon including indicia identifying the drug to be administered.

In accordance with one embodiment of the present invention there is described a method for recording drug administration to a patient, the method comprising providing a display for displaying the amount of a drug administered to a patient, displaying an icon including indicia identifying the drug being administered on the display, administering the drug to a patient, determining the amount of the drug administered to the patient, and displaying on the display at a location proximate the location of the icon the amount of the drug administered, wherein the icon includes a color designation indicia associated with the identification of said drug.

### BRIEF DESCRIPTION OF THE DRAWINGS

The present invention, as well as further objects, features and advantages of the present invention will be more fully understood with reference to the following detailed description of a system and method for displaying drug information, when taken in conjunction with the accompanying drawings which illustrate the embodiments of the present invention.

FIG. 1 is a diagrammatical representation of an icon including drug identification indicia in accordance with one embodiment of the present invention;

FIGS. 2(a)-(d) are diagrammatical representations of icons having color coded indicia representing different drug classes in accordance with one embodiment of the present invention;

FIGS. 3(a)-(c) are diagrammatic representations of icons having color coded indicia representing various drug concentrations in accordance with one embodiment of the present invention;

FIGS. 4(a)-(c) are diagrammatic representations of icons having color coded indicia representing various drug concentrations in accordance with another embodiment of the present invention;

FIGS. 5-8 are representations of a computer display screen showing an icon in accordance with one embodiment of displaying drug information pursuant to the present invention;

FIG. 9 is a diagrammatic illustration of a drug administration display system in accordance with one embodiment of the present invention;

FIG. 10 is a flow diagram illustrating a method for displaying drug information in accordance with one embodiment of the present invention; and

FIGS. 11(a)-(e) are diagrammatic representations of icons in accordance with other embodiments of the present invention.

### DETAILED DESCRIPTION

In describing the preferred embodiments of the present invention, specific terminology will be resorted to for the sake of clarity. However, the invention is not intended to be limited to the specific terms so selected, and is to be understood that each specific term includes all technical equivalence which operate in a similar manner to accomplish a similar purpose.

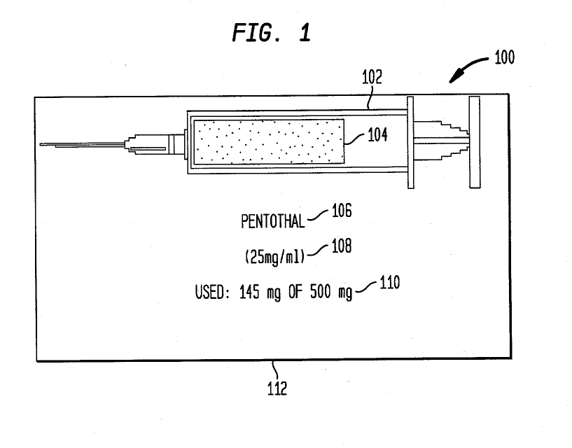

Referring to FIG. 1, there is illustrated one feature of the present invention in the nature of an icon or graphic image generally designated by reference numeral 100. The icon 100 graphically depicts a drug delivery device which, in accordance with one embodiment, is illustrated by syringe graphics 102 illustrating a syringe of known design. The icon 100 may include other information or indicia in graphic, text or color form aside from the syringe graphics 102. For example, the syringe graphics 102 may include drug graphics 104 which may be visually coded such as by color, graphics indicia, text and the like. The icon 100 may also include information such as the drug name 106 or generic or brand name, drug concentration 108, amount of drug administered 110 and a background section 112 which may be coded, for example, such as color, graphics, indicia and the like. The icon 100 will provide the health care professional with a substantial amount of information and data with respect to the drug to be administered. As this information is presented in the form of an icon, vis-à-vis graphics, text and/or color, the information is visually presented to the health care provider in a manner which is easily viewed and quickly assimilated to reduce the likelihood of drug delivery errors.

The icon 100 has been described as including syringe graphics 102 and a background 112. However, it is to be understood that the background 112 is optional, in this regard, the icon 100 including only the syringe graphics 102. The syringe graphics 102, as thus described, may include drug graphics 104 which may be visually coated such as by color, graphics, indicia, text and the like.

It is also contemplated that the syringe graphics 102 may be in other forms or illustrations. For example, the icon 100 may graphically depict other drug delivery devices, such as an IV bag, a syringe pump, an ampoule, and the like. It is further contemplated that the icon 100 may graphically depict other symbols or objects other than a drug delivery device, for example, an arrow, a person's pointing finger, and the like. These graphic symbols may also include drug graphics 104 which may be visually coded such as by color, graphics, indicia, text and the like.

The drug graphics 104 and/or the background color 112 if present may be used to represent different drug classes, such as anticholinergics, benzodiazepines, muscle paralyzers, narcotics, and the like. By way of example, it is known to color code classes of drugs by the manufacturer or by the hospital pharmacy, i.e., relaxants-fluorescent red, opioides-blue, vasopressors-violet, and local anesthetics-gray. By using a color coding system, or other visual indicia, the health care professional will immediately be able to identify whether the drug being administered is at least within the drug class intended.

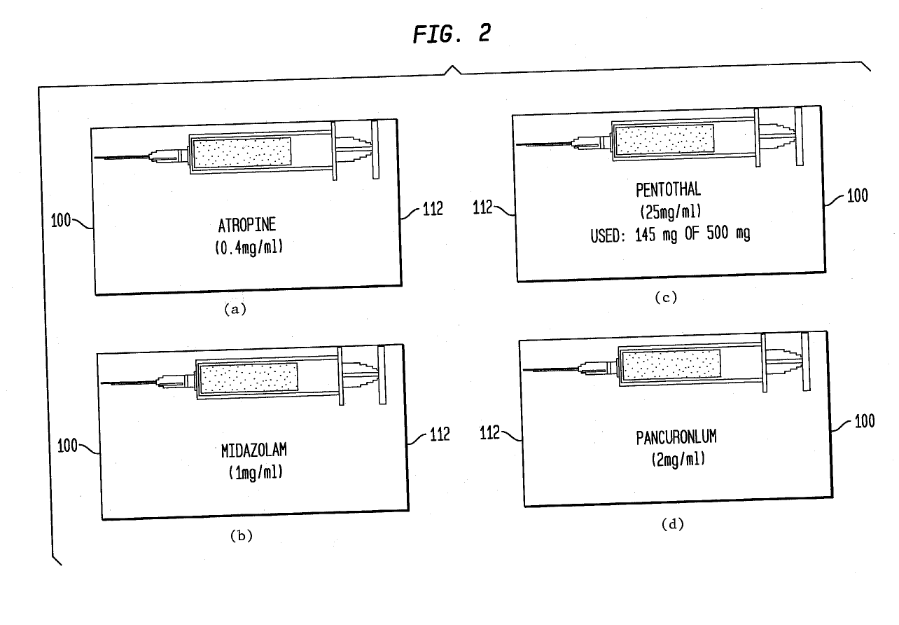

Referring to FIG. 2, the icon 100 has a green color background 112 for the drug atropine, a light blue color for narcotics, an orange color for the drug midazolam and a red color for the drug pancuronium. In the foregoing example, atropine is a known anticholinergic, Midazolam is a known benzodiazepine, Pentothal is a known sedative hypnotic and pancuronium is a known muscle paralyzer. The color coding may preferably be based upon a national government drug standard which would be universal in nature. However, other color codings such as a manufacturer's color code, a hospital-based color code or those based upon other health care professional criteria can be used. In each case, the particular color will signal to the health care professional information about the particular drug being administered. The adoption of this visual feedback mechanism and its ability to easily adapt to developing standards provides an improvement in the field of clinician or health care professional to information which will minimize the inadvertent administration of the wrong drug. It is contemplated that the drug graphics 104 can be similarly color coded.

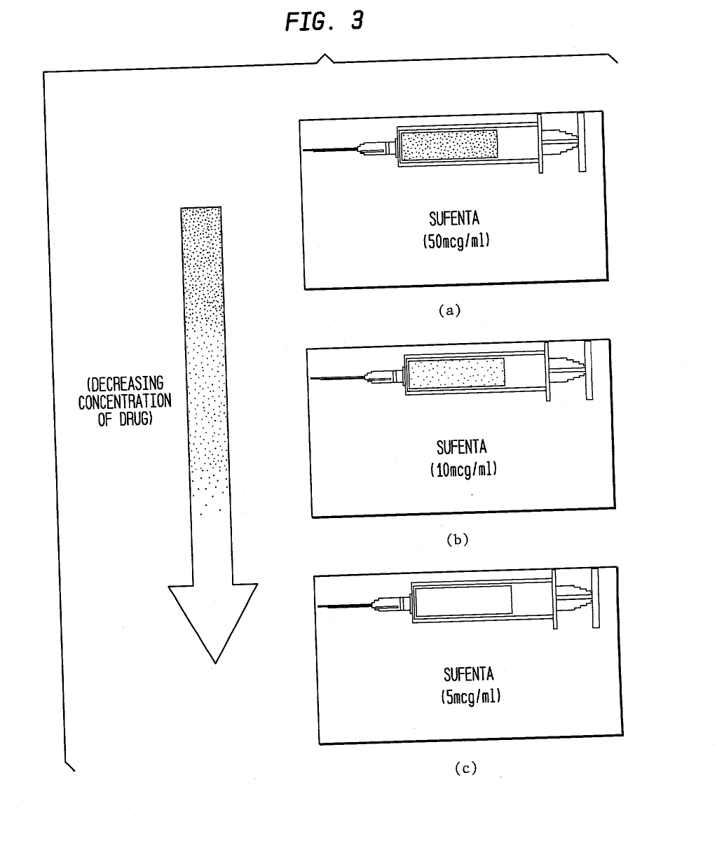

The drug graphics 104 can also be used as a graphic indicator of the concentration of the drug contained within the syringe. Referring to FIGS. 3A-C, the color of the drug graphics 104 fades to a lower value or shade as the concentration is reduced. For example, a dark blue drug graphics 104 in FIG. 3A may represent 50 mcg/ml of sufenta, while a light blue drug graphics in FIG. 3B may represent 10 mcg/ml of sufenta, while a relatively pale blue graphics 104 in FIG. 3C may represent 5 mcg/ml of sufenta. The shade color variation can also be used in the background section 112 of the icon 100.

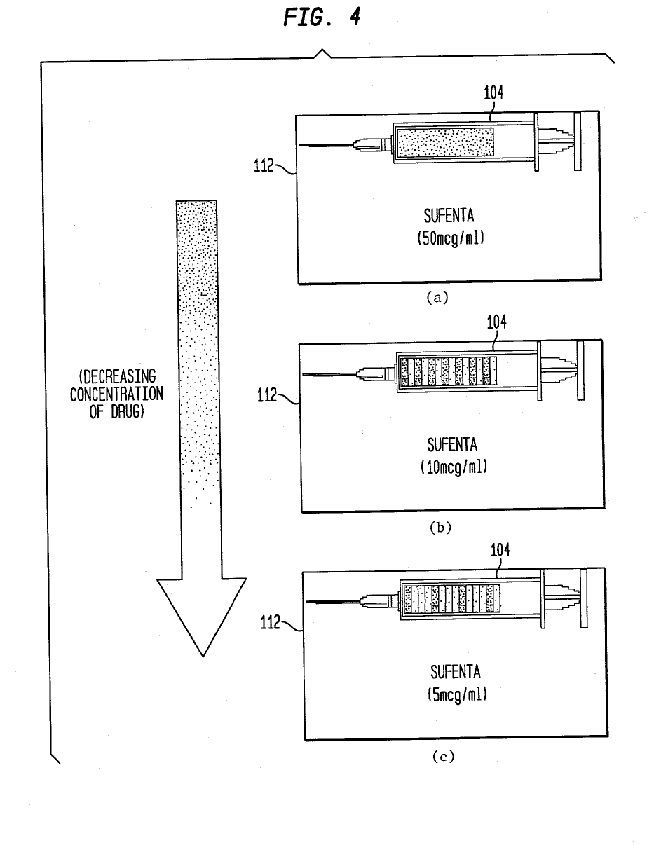

Referring to FIGS. 4A-C, there is disclosed another embodiment of indicating drug concentration using drug graphics 104. As the concentration of the drug in the syringe is reduced (diluted) the relative number of bars or hatch marks representing the fluid by the drug graphics 104 in the syringe graphics 102 is likewise reduced. A solid graphic, FIG. 4A, represents the undiluted or concentrated medication whereas the progressively spaced graphic bars of the drug, e.g., FIG. 3(c), indicates more dilution of the drug in the syringe. The spaced graphic bars can also be used in the background section 112 of the icon 100.

It is common practice to dilute very powerful medications to a point where they can be injected in a bolus fashion to provide rapid effect and the ability to titrate the dose in an acute or rapidly changing clinical situation. Trouble arises when fully concentrated drugs are mistaken for dilute ones and injected in overdose amounts. The use of a graphic indicator of drug concentration as described pursuant to the embodiments of the present invention reduces or eliminates the likelihood of this type of medication error.

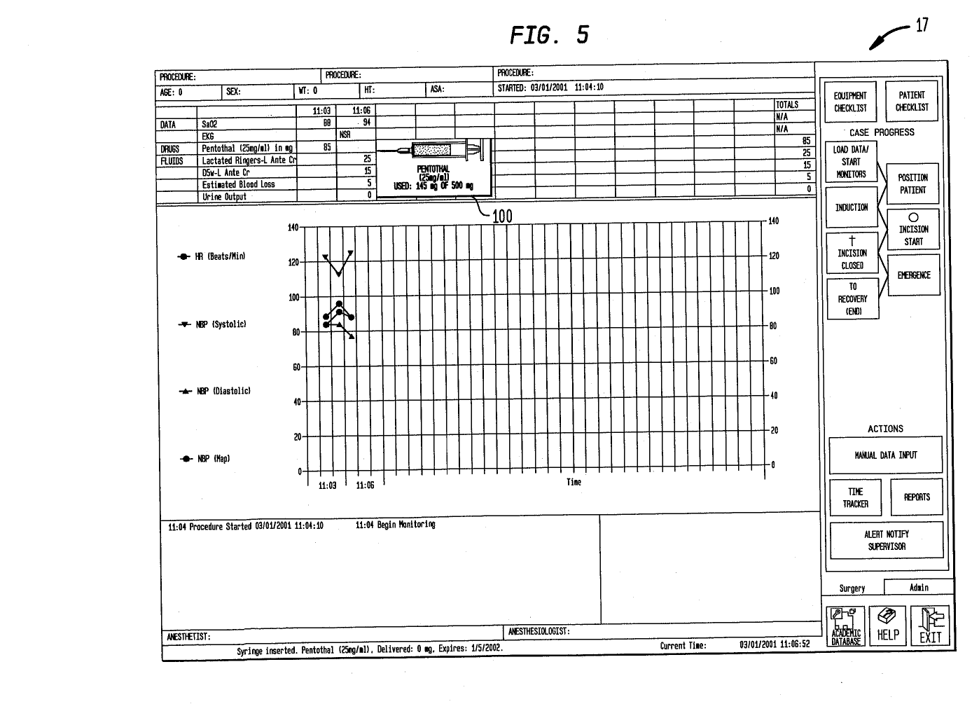

In accordance with one aspect of the present invention, the icon 100 is visually displayed on a computer monitor attached to a programmed computer which may be part of an overall drug administration system such as that disclosed in the aforementioned '775 Patent. The drug administration system will provide information and data to the health care professional in the form of one or more computer screens containing the requisite information and data as may be required. By way of one example only, FIG. 5 shows a display screen 114 appearing on a monitor which is part of a computerized anesthesia record. The top section of the display screen 114 includes certain patient identifier data and specific details related to the surgical procedure being performed. The next section contains in tabular form numerical information such as the results of patient fluid infusion, drug administration data, vital sign data and the like. The tabular information by being numerical in nature provides an instantaneous readout. The tabular information may be updated in real time or at prescribed time intervals as may be desired by the health care provider and the programmed implementation of the system. For example, a urine output analyzer may be connected to the computer system for displaying the urine output in real time. The center section of the display screen 114 provides a graphical representation of the patient's vital signs in real time. As the graph covers a predetermined time interval, the health care professional can view the patient's vital signs over a trended graph to determine fluctuations during the surgical procedure. These vital signs may also be provided as tabular information to display a current numerical value as previously described. The bottom section may be reserved for comments and notes which may be inputted via a keyboard, writing pad, or other input device. The rightmost panel of the display screen provides certain control push buttons for navigation to other parts of the computer program, displaying other display screens or other desirable functions of the computer system.

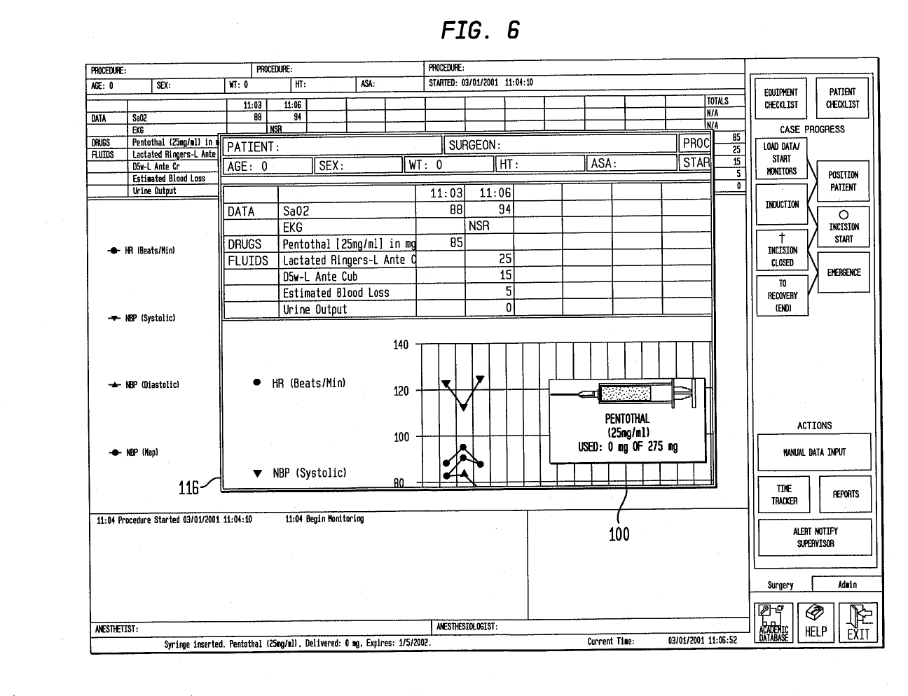

As shown in FIGS. 5-8, the icon 100, in accordance with one embodiment, is in the nature of a floating icon which is overlaid over the display screen 114. Prior to drug administration, the icon 100 may be positioned overlying any portion of the display screen 114. For example, the icon 100 may be positioned over the graphical representation of the patient's vital signs in a manner which would not prevent the health care professional from reading the data and information from the display screen 114. In addition to being directly positioned within the display screen 114, the icon 100 may also be provided within a secondary or insert window 116 which provides an enlarged portion of the display screen such as shown in FIG. 6. In the preferred embodiment, the icon 100 will be positioned directly on the display screen 114 whereby all of the data and information in the display screen will be observable by the health care professional.

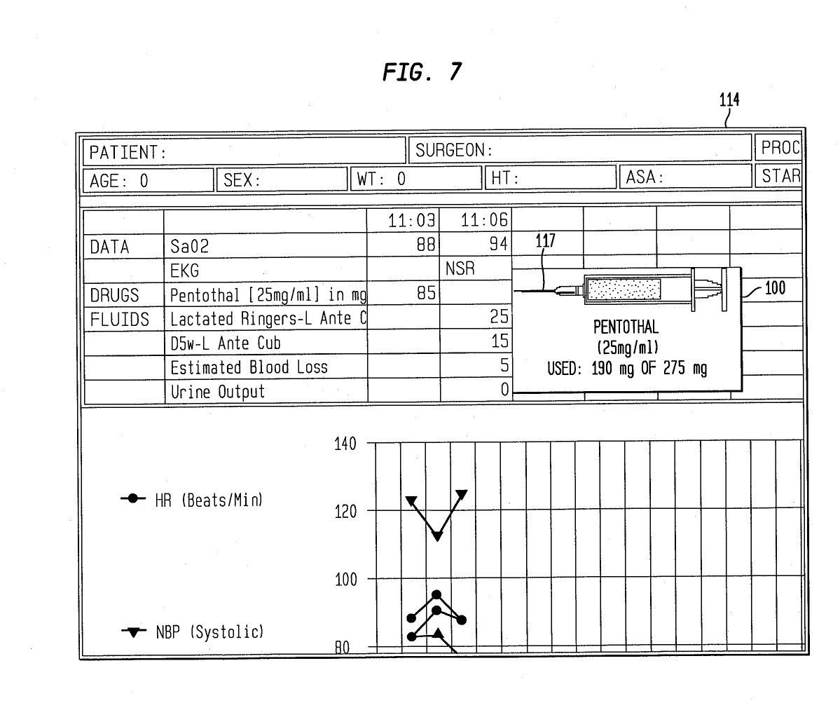

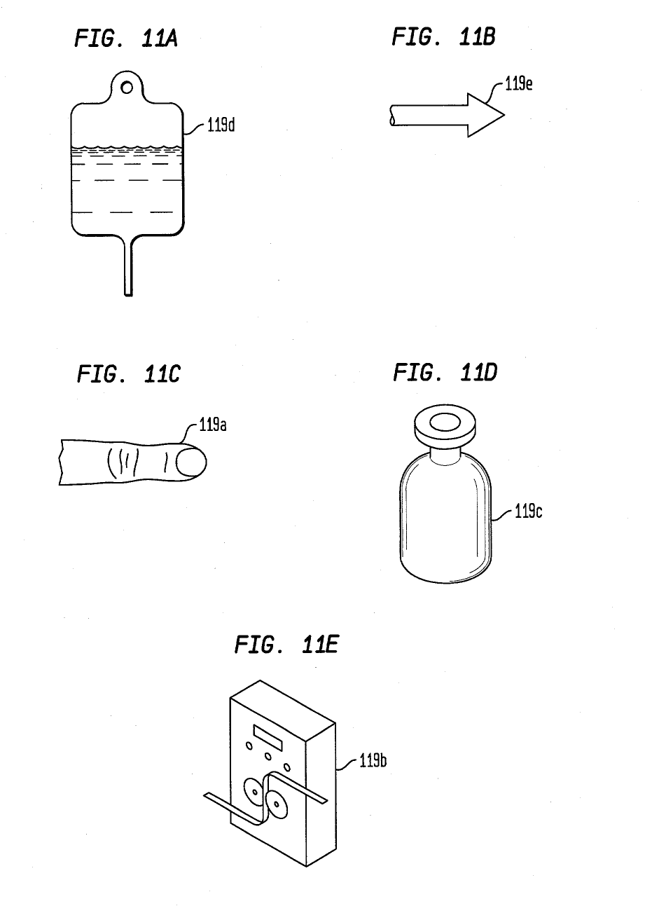

Upon initiation of drug administration, the icon 100 will move across the display screen 114 to a position in alignment with the region or location where the drug administration data is to be recorded as tabular information. As shown in FIG. 7, the icon 100 has moved to a location within the section containing the tabular information. More specifically, the needle 117 of the syringe graphics 102 is aligned with the empty box where the amount of pentothal is to be recorded at the time of drug administration. A similar arrangement may be used for pointing graphics 102 when in the form of a finger 119(a), syringe pump 119(b), arrow 119(e), ampoule 119(c), IV bag 119(d), etc., see FIG. 11.

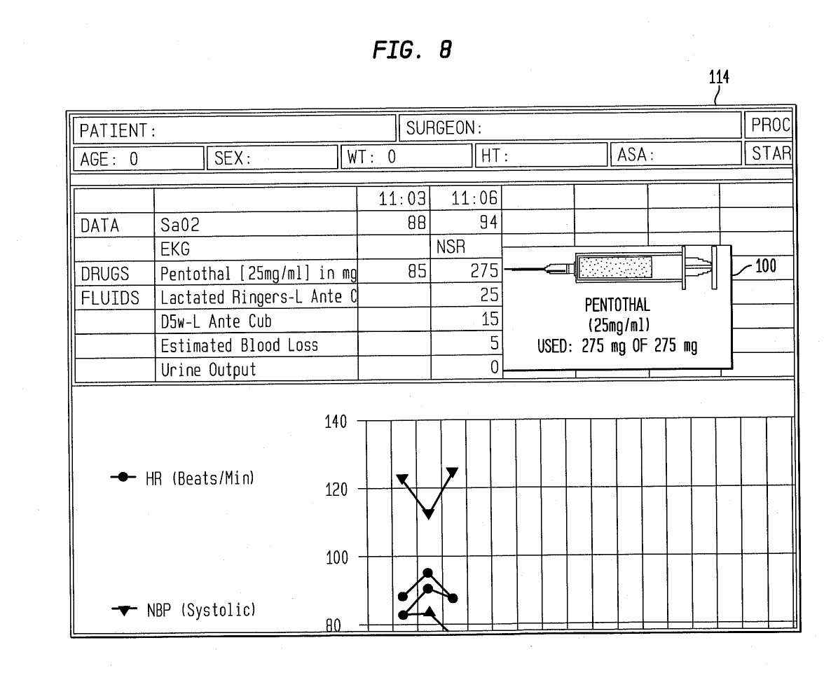

As shown in FIG. 7, a prior recording at 11:03 indicates that 85 mg of pentothal were administered. At 11:06, administration of additional pentothal is about to begin, as graphically indicated by the position of the icon 100 within the display screen 114. As the drug is being administered to the patient, the amount thereof will appear in real time on the display screen 114. Simultaneously, the drug graphics 104 and position of the syringe plunger may be altered to show drug administration as shown in FIG. 8. The health care professional is therefore provided with both a graphical and numerical indication of drug administration and the quantity thereof, in real time. The monitoring of drug administration in real time to provide the data to be displayed can be achieved using various techniques as disclosed in the aforesaid '775 Patent. In addition to the disclosed techniques in the '775 Patents, other methods known in the art may be used, such as, by way of example, fluid resistance measurement, mechanical techniques and the like.

Although the icon 100 has been disclosed as floating, or moveable about the display screen 114, it may be positioned in a stationary location if desired. In addition, the icon 100 may only appear at the moment of drug administration at the location where the drug data is to be entered, such as in FIG. 7. It is also contemplated that more than one icon 100 can be displayed at the same time such as when more than one drug is being administered. The icons 100 may be the same or have different shapes and/or forms.

As thus far described, the icon 100 can have a variety of shapes and forms, e.g., syringe, syringe pump, an ampoule, an IV bag, an arrow, etc. The icons 100 and the indicia represented thereby, e.g., color designation, text material, etc. is created by a software program stored in a computer designed for creating the icon 100 and moving same about the display as described in accordance with one aspect of the present invention. In this regard, the specific graphic nature and information content of the icon 100 may be selected from a list provided to the user of the drug delivery system. The specific icon 100 can be selected from a menu drop down list on the display.

The icon 100 and syringe graphics 102 is one of a number of features in the adverse drug event prevention system in the perioperative management network of the present invention. The perioperative management network of the present invention can provide many different functions, such as those previously described. The network, in accordance with one embodiment, is operative to link pharmacists and anesthesiologists together to provide information in a timely manner in a context most likely to positively impact patient care.

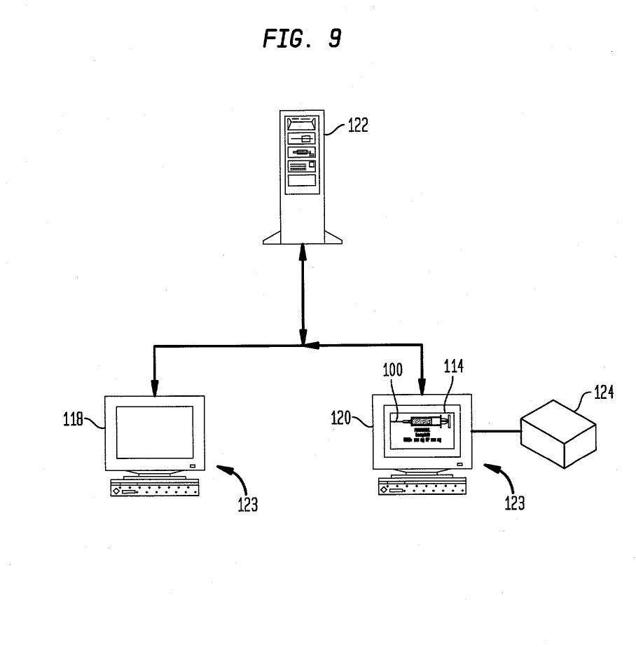

As shown in FIG. 9, a computer based pharmacy workstation 118, a computer based anesthesia workstation 120, and a computer database server 122 are operatively coupled via a data link, e.g., fiber optic, I.R., cable, etc., in the system forming the network. By way of example, the pharmacy workstation 118 and anesthesia workstation 120 each include a known computer based system 123, such as a desktop or notebook computer which include a data storage device, display device, keyboard, etc. Any form of computer such as a microprocessor based system is contemplated, including remote terminals and the like. On the pharmacy workstation 118 a custom formulary reference software application exists which allows the pharmacist to enter a variety of information considered to be important about specific drugs and drug classes. As relating to syringe color coding, the pharmacist can specify the desired color for any given drug class and can assign specific medications to be members of a particular drug class. The formulary reference is a network-based software application and sends the pharmacist's selections to be stored in a relational database in a suitable data storage device on the server 122. Whenever there is a change to information containing individual medications or drug classes, this version of the information is modified in the server 122 so that any application that stores local copies of the information will be flagged to replace the local version with the version on the server.

It should be understood that multiple pharmacy workstations 118 and anesthesia workstations 120 can be provided throughout, for example, a hospital, all connected to a common database server 122. It is also contemplated that plural database servers 122 can be provided which may be independent or interconnected via a network. Accordingly, individual pharmacy and anesthesia workstations 118, 120 can be located about the hospital. In addition, pharmacy workstations and anesthesia workstations at other locations than a single hospital may be interconnected to a common or multiple database servers. In this manner, a gridwork of hospitals at a particular location, or even nationally or internationally can be linked together for accessing relevant data information about a particular patient and/or drug. The interconnecting of one system with another can be through any suitable means, for example, via the Internet, satellite communications, fiberoptic networks, or the like.

The anesthesia workstation 114 runs a stored anesthesia record software program and is connected to a drug monitoring system 124, for example, of the general type disclosed in the '775 Patent for monitoring drug administration in real time. When the anesthesia record software begins, it checks the database on the server 122 to see if there have been any updates to local data or information that it uses. Among this data is the medication information. If the local version of the medication information is outdated, the anesthesia record software will request that a new version be sent to it by the database server. By this method, any modifications to specified colors for drug classes will be obtained. The pharmacy workstation 118 and anesthesia workstation 120 include a computer, microprocessor or other operating computer platform to perform their intended operation in accordance with the present invention.

When administering medication to a patient, the health care professional will slide a syringe label cradle unit which includes a syringe and a syringe cradle as disclosed in the '775 Patent into the scanning module of the drug monitoring system 124. This will trigger an internal bar code scanner to read the contents of a bar code on a label which is adhered to the syringe label cradle unit. The bar code will be interpreted to determine the unique identifier of the medication in the syringe. This identifier will be presented to the local database to retrieve the name, concentration, expiration date of the medication, as well as the pharmacist specified color of the drug class of which the medication is a member. The anesthesia record software will then display an icon 100 of a syringe graphic 102 whose contents are the specified color with the indicated amount being relative to that of the contents of the actual syringe. The color will serve as another indicator that the appropriate syringe is being used. For example, if the anesthetist thinks that an antibiotic is about to be given but sees the color for a narcotic, this will cause the anesthetist to double check the syringe and prevent a misadministration. As medication is delivered from the syringe the length of the colored drug graphics 104 in the syringe graphic 102 shrinks and the volume in the numerical data on the anesthesia record on the display screen 114 is updated in real time. This gives the visual impression of drugs being delivered into the appropriate tabular cell on the patient record of the display screen 114. When the syringe is removed from the drug monitoring system the flying icon 100 may be programmed to disappear.

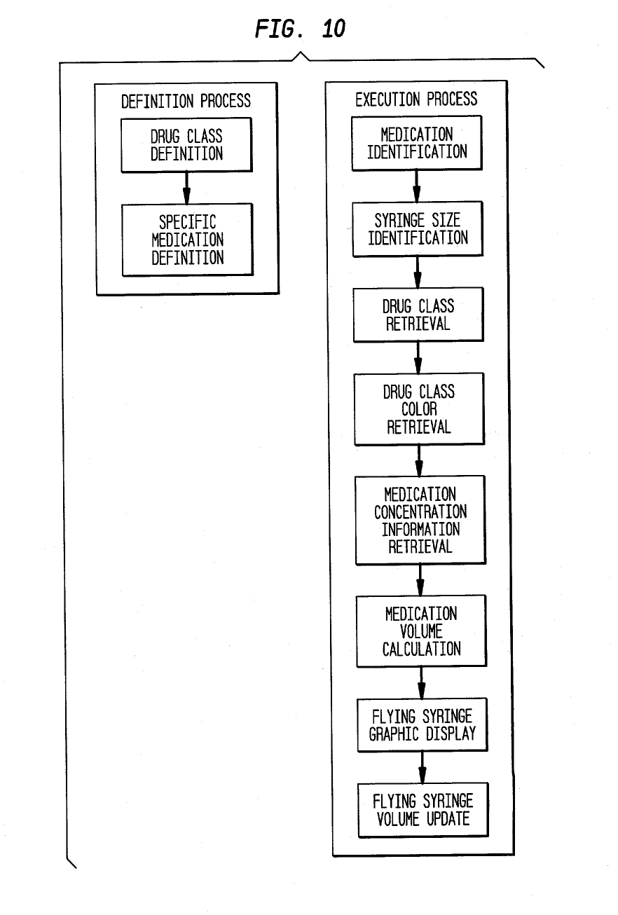

Two processes as thus far described are implemented to provide the syringe icon functionality—definition and execution. The definition process includes the steps used to capture the specific drug class and medication parameters and the execution process includes the steps to be performed each time a syringe icon is to be presented, see FIG. 10. The definition and execution process are further described in accordance with one illustrated embodiment of the present invention as follows:

Definition Process

1. Drug class definition—Enter the desired name and color information for the selected drug class through a computer graphical user interface (GUI). Connect to the target relational database. Add or update the drug class information in the relational database through a stored procedure.

2. Specific medication identification—Enter the specific medication information through a GUI. The information to be entered may include, but is not limited to, the name of the medication, the concentration, and the drug class in which the specific medication should be a member. The system user can be allowed to select the desired drug class by means of a drop-down list which can be linked to a unique identifier. Once the data has been obtained, add or update the information to the medication information in the relational database.

Execution Process

1. Medication identification—Enter the contents of a barcode affixed to a syringe label cradle unit through either a serial port or keyboard wedge barcode scanner. Decode the barcode either through a lookup table or relational database to obtain a unique medication identifier.

2. Syringe size identification—Using a lookup table or relational database, decode the bar code information obtained in step 1 to retrieve the size of the syringe being employed.

3. Drug class retrieval—Connect to a relational database and, using the medication identifier obtained in step 1, execute a stored procedure to retrieve a unique identifier for the class in which the identified medication is a member.

4. Drug class color retrieval—Connect to a relational database and, using the drug class identifier obtained in the previous step, execute a stored procedure to retrieve the color defined for the desired drug class.

5. Medication concentration information retrieval—Using the medication identifier obtained in step 1, retrieve the concentration information for the desired medication.

6. Medication volume calculation—Calculate drug volume administered as described in the '775 Patent or other method known in the prior art.

7. Syringe graphic display—Display a window which contains a graphical image of a syringe. Inside the body of the graphical syringe, use either a picture box or other indicia to represent the volume of medication in the actual syringe. Calculate the percentage fullness of the syringe by dividing the volume from step 6 by the syringe size obtained in step 2. Fill the percent full on the syringe graphic with the color defined for the given drug class and fill the percent empty on the syringe with white. Examples: If the actual syringe is full, have the entire length of the syringe body filled with the color of the medication's drug class that was obtained in step 3. If the syringe is empty, color the entire body white. If the syringe is half full, fill half the body with the drug class color and the remainder white.

8. Syringe volume update—Repeat step 6 as necessary to calculate the contents of the syringe. As medication is delivered, the content of the syringe will decrease. Repeat step 7 as necessary and redraw the syringe with the updated volume. As the graphical contents of the syringe is reduced, an accumulated volume of drug delivered can be entered into an appropriate data cell.

Although the invention herein has been described with reference to particular embodiments, it is to be understood that these embodiments are merely illustrative of the principles and applications of the present invention. Further, any range of numbers or ratios recited in the specification describing various aspects of the invention, such as that representing a particular set of properties, units of measure, conditions, physical states or percentages, is intended to literally incorporate expressly herein by reference or otherwise, any number or ratio falling within such range, including any subset of numbers or ranges subsumed within any range so recited. It is therefore to be understood that numerous modifications may be made to the illustrative embodiments and that other arrangements may be devised without departing from the spirit and scope of the present invention as defined by the appended claims.

1. A drug administration display system comprising a display, a storage device for storing drug data, a first station for entering drug data for storage by said storage device, a drug monitoring system for monitoring drug administration, and a second station for accessing the drug data in said storage device in response to the drug monitoring system for displaying on said display an icon including indicia identifying the drug being administered.

2. The system of claim 1, wherein said icon includes indicia selected from the group consisting of drug name, drug concentration, drug volume and drug color designation.

3. The system of claim 1, wherein said icon comprises a graphic representation of a syringe.

4. The system of claim 1, wherein said storage device contains a database of drug names each associated with a color designation.

5. The system of claim 4, wherein said icon includes said color designation.

6. The system of claim 4, wherein said icon includes drug concentration indicia of said drug.

7. The system of claim 1, wherein said first station comprises a pharmacy workstation and said second station comprises an anesthesia workstation.

8. The system of claim 1, wherein said first and second stations each include a computer system.

9. A drug display system comprising a display, and a computer programmed to display an icon on said display including indicia identifying a drug to be administered to a patient.

10. The system of claim 9, wherein said icon includes indicia selected from the group consisting of drug name, drug concentration, drug volume and drug color designation.

11. The system of claim 9, wherein said icon comprises a representation of a syringe.

12. The system of claim 9, wherein said icon includes drug concentration indicia of said drug.

13. The system of claim 9, wherein said icon includes color designation indicia identifying said drug.

14. The system of claim 9, further including a storage device for storing a database of drug data for a plurality of drugs each associated with a color designation indicia, said database accessible by said computer.

15. The system of claim 9, wherein said icon is selected from the group consisting of a representation of a finger, arrow, syringe pump, ampoule and IV bag.

16. The system of claim 9, further including a storage device for storing data retrievable by said computer.

17. A method for identifying a drug for administration to a patient, said method comprising displaying on a display an icon including indicia identifying the drug to be administered.

18. The method of claim 17, wherein said icon comprises a graphic representation of a syringe.

19. The method of claim 17, wherein said icon includes indicia selected from the group consisting of drug name, drug concentration, drug volume and drug color designation.

20. The method of claim 17, wherein said icon includes color designation indicia identifying said drug.

21. The method of claim 17, wherein said icon includes drug concentration indicia of said drug.

22. The method of claim 17, further including positioning said icon on said display at a first location prior to administration of said drug and at a second location at the start of drug administration.

23. The method of claim 22, further including displaying on said display adjacent said second location the amount of said drug administered.

24. The method of claim 17, further including storing drug data for a plurality of drugs in a database, each of said drugs being associated with a color designation indicia.

25. The method of claim 24, wherein said indicia identifying said drug to be administered corresponds to one of said color designation indicia.

26. The method of claim 17, wherein said icon comprises a graphic representation of a syringe and a background section.

27. The method of claim 17, further including displaying a plurality of icons on said display at the same time.

28. The method of claim 17, further including displaying on said display the amount of said drug being administered to a patient in real time.

29. A method for recording drug administration to a patient, said method comprising providing a display for displaying the amount of a drug administered to a patient, displaying an icon including indicia identifying the drug being administered on the display, administering said drug to a patient, determining the amount of the drug administered to said patient, and displaying on the display at a location proximate the location of said icon the amount of said drug administered, wherein said icon includes a color designation indicia associated with the identification of said drug.

30. The method of claim 29, wherein said icon comprises a graphic representation of a syringe.

31. The method of claim 29, wherein said icon includes indicia selected from the group consisting of drug name, drug concentration and drug administration volume.

32. The method of claim 29, wherein said icon includes drug concentration indicia of said drug.

33. The method of claim 29, further including storing drug data for a plurality of drugs in a database, each of said drugs being associated with a color designation indicia.

34. The method of claim 33, wherein said indicia identifying said drug to be administered corresponds to one of said color designation indicia.

35. The method of claim 29, positioning said icon on said display at a first location prior to said administration step and moving said icon proximate to said location for displaying the amount of said drug administered at the start of said drug administration.

36. The method of claim 29, wherein the amount of said drug being administered is displayed on said display in real time.

37. The method of claim 29, further including displaying a plurality of icons on said display at the same time.
